(19) United States
(12) Patent Application Publication
(10) Pub. No.: US 2013/0204979 A1
(43) Pub. Date: Aug. 8, 2013

(54) DIGITAL DATA COMMERCE SYSTEM AND METHODS WITH DIGITAL MEDIA OBJECT TO CLOUD REDIRECTION

(71) Applicant: ReDigi, Inc., Cambridge, MA (US)

(72) Inventors: Lawrence S. Rogel, Brookline, MA (US); John M. Ossenmacher, Balboa Island, CA (US); Jonathan Lin, Cambridge, MA (US); Xiao Zou, Roxbury Crossing, MA (US)

(73) Assignee: ReDigi, Inc., Cambridge, MA (US)

(21) Appl. No.: 13/760,823

(22) Filed: Feb. 6, 2013

Related U.S. Application Data
(60) Provisional application No. 61/595,563, filed on Feb. 6, 2012.
(60) Provisional application No. 61/642,983, filed on May 4, 2012.

(51) Int. Cl. H04L 29/08

(52) U.S. Cl. CPC H04L 29/08081
USPC 709/219; 709/217

(57) ABSTRACT

The invention provides, in some aspects, a digital commerce system that includes a first digital data device, a second digital data device and a third digital data device, each of which is connected to a network that provides at least intermittent communications coupling between the second digital data device and each of the first and second digital data devices. Redirection logic executing on at least the second digital data device effects storage on the third digital data device of a digital media object downloaded from the first digital data device to the second digital data device. The redirection logic accomplishes that in such a manner that storage of the digital media object on the third digital data device is effected before storage of that digital media object on the second digital data device—if the digital media object is stored to the second digital data device at all. In related aspects of the invention, redirection logic executing on at least the second digital data device circumvents storage of the downloaded digital media object at least until that object has been stored on the third digital data device.

This claims the benefit of filing of U.S. Patent Application Ser. Nos. 61/595,563, filed Feb. 6, 2012, and 61/642,983, filed May 4, 2012, both entitled “Systems And Methods For Music Resale, Transfer And Streaming With Direct To Cloud Storage,” the teachings of both of which are incorporated herein by reference.

### BACKGROUND OF THE INVENTION

The invention pertains to digital media handling and, more particularly, for example, to the transfer of digital media objects, e.g., digital files embodying creative works. The invention has application, by way of non-limiting example, in the (re)sale, lending, streaming or other transfer of digital music, digital books, games, apps or programs, and other digital media objects.

U.S. patent application Ser. No. 13/406,237 and corresponding PCT Patent Application Serial No. PCT/US2012/026,776 (now, Publication No. WO 2012/116365), the teachings of all of which are incorporated by reference herein, discloses inter alia methods, apparatus and systems suitable for the (re)sale or other transfer of digital media objects which methods and apparatus include, inter alia, atomically transferring ownership of those objects so that at no instant in time are copies of them available to both buyer and seller—but, rather, may be available only to the seller prior to sale and only to the buyer after sale. While those techniques are effective, further improvements are desirable as to acquisition of digital media objects by sellers in the first instance, e.g., from servers of digital media sellers and distributors whence they may have been originally downloaded.

An object of this invention is to provide improved methods, apparatus and systems for digital commerce.

A related object is to provide such methods, apparatus and systems as facilitate the (re)sale, lending, streaming or other transfer of digital music, digital books and other digital media objects.

A further related object is to provide such methods, apparatus and systems as facilitate acquisition of digital media objects by sellers in the first instance, e.g., from servers of digital media sellers and distributors whence they may have been originally downloaded.

### SUMMARY OF THE INVENTION

The foregoing are among the objects attained by the invention, which provides in some aspects a digital commerce system that includes a first digital data device, a second digital data device and a third digital data device, each of which is connected to a network that provides at least intermittent communications coupling between the second digital data device and each of the first and third digital data devices. Redirection logic executing on at least the second digital data device effects storage on the third digital data device of a digital media object downloaded from the first digital data device to the second digital data device. The redirection logic accomplishes that in such a manner that storage of the digital media object on the third digital data device is effected before storage of that digital media object on the second digital data device (if stored to the second digital data device at all). In related aspects of the invention, redirection logic executing on at least the second digital data device circumvents storage of the downloaded digital media object at least until that object has been stored on the third digital data device.

Further related aspects of the invention provide a digital commerce system, e.g., as described above, wherein the first digital data device and third digital data device are server devices, and wherein the second digital data device is a client device. In further related aspects of the invention, the first digital data device is a digital media server, e.g., of the type employed by electronic music, electronic book and other digital media sellers and distributors. The client device, moreover, can execute digital media client software that requests, at the behest of a user of the second digital data device, download of a digital media object comprising such music, books or other digital media from the first digital data device.

Still further related aspects of the invention provide a digital commerce system, e.g., as described above, wherein the first digital data device responds to a request from the second digital data device for a digital media object by packetizing the object and sending the resultant packets to the second digital data device. Those packets embody, according to related aspects of the invention, respective portions of the digital media object.

Other related aspects of the invention provide a digital commerce system, e.g., as described above, wherein the digital media client executing on the second digital data device responds to packets received from the first digital data device by issuing calls to write those packets to a file on the second digital data device. Redirection logic executing on the second digital data device effects interception of file system operation calls, including calls to write packets to the file, issued by that media client. Such interception is effected by the redirection logic, for example, via cooperation with the operating system and/or filesystem of the second digital data device.

Still other related aspects of the invention provide a digital commerce system, e.g., as described above, wherein the redirection logic executing on the second digital data device transmits the intercepted calls to the third digital data device, e.g., along with packets, data and/or other information that accompanied the intercepted calls (as made by the digital media client). The redirection logic can, according to some aspects of the invention, supplement or alter the intercepted calls transmitted to the third digital device, e.g., in accord with a protocol for cooperation with redirection logic executing on the third digital data device.

Related aspects of the invention provide a digital commerce system, e.g., as described above, wherein the redirection logic executing on the second digital data device transmits packets received with the intercepted calls to the third digital data device. That logic can continue so doing until the last packet embodying a portion of the digital media object has been received by the second digital data device from the first digital data device and has been transmitted to the third digital data device. In other aspects, the redirection logic executing on the second digital data device effects downloading of the digital media object or a copy thereof from the third digital data device to the second digital data device after the last packet embodying a portion of the digital media object has been transmitted to the third digital data device.

Yet still other aspects of the invention provide methods paralleling operation of the digital commerce systems described above.

The foregoing and other aspects of the invention are evident in the drawings and in the text that follows.

### BRIEF DESCRIPTION OF THE DRAWINGS

A fuller appreciation of the invention and embodiments there may be attained by reference to the drawings, in which:

FIG. 1 depicts a digital data processing system of the type in which the invention is practiced;

FIGS. 2-3 depict a system and method according to one practice of the invention at initial stages of digital media object redirection; and

FIGS. 4-7 depict a system and method according to one practice of the invention at later stages of digital media object redirection.

### DETAILED DESCRIPTION OF THE ILLUSTRATED EMBODIMENT

### System Architecture

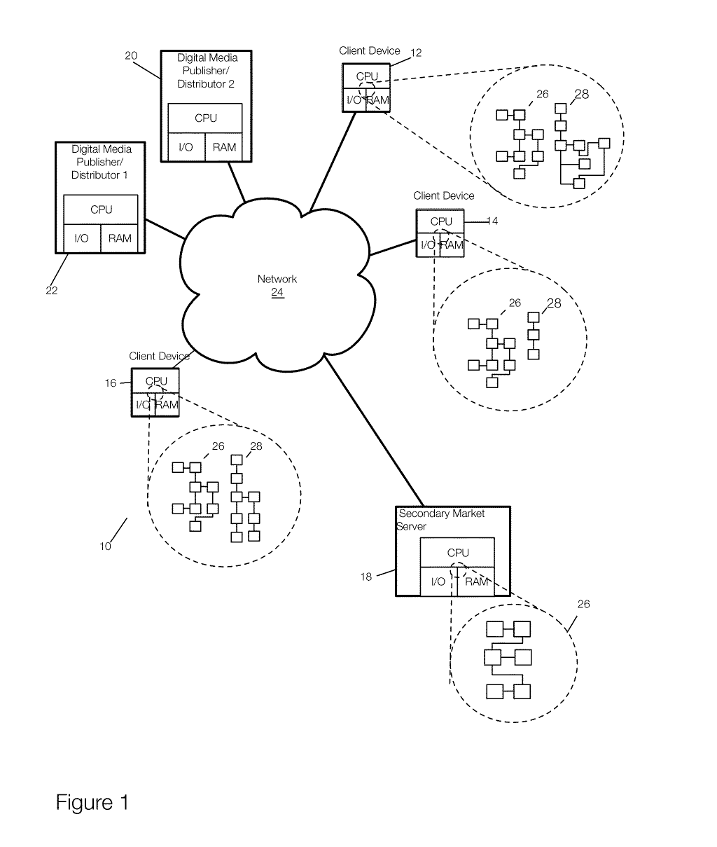

FIG. 1 depicts a system 10 supporting electronic commerce of the type in which the invention may be practiced. The illustrated system includes one or more client digital data devices 12-16 and one or more server digital data devices 18-22, each comprising mainframe computers, minicomputers, workstations, desktop computers, portable computers, tablet computers, smart phones, personal digital assistants or other digital data apparatus of the type commercially available in the marketplace, as adapted in accord with the teachings hereof. As such, each of the devices 12-22 is shown as including CPU, I/O and memory (RAM) subsections, by way of non-limiting example.

The digital data devices 12-22 may be connected for communications permanently, intermittently or otherwise by a network, here, depicted by “cloud” 24, which may comprise an Internet, metropolitan area network, wide area network, local area network, satellite network, cellular network, and/or a combination of one or more of the foregoing, as adapted in accord with the teachings hereof. And, though shown as a monolithic entity in the drawing, in practice, network 24 may comprise multiple independent networks or combinations thereof.

Client digital data devices 12-16 operate in the conventional manner known in the art as adapted in accord with the teachings hereof with respect to the transfer of “digital media objects” embodying creative works, such as by way of non-limiting example, digital songs, videos, movies, electronic books, stories, articles, documents, still images, video games, other software, and/or combinations of the foregoing—just to name a few. The client digital data devices typically comprise desktop computers, portable computers, tablet computers, smart phones, personal digital assistants or other computer apparatus of the type commercially available in the marketplace, as adapted in accord with the teachings hereof, though other devices such as mainframe computers, minicomputers, workstations may be employed as client digital data devices as well (again, so long as adapted in accord with the teachings hereof).

As used herein a digital media object (or DMO) refers to a collection of bits or other digital data embodying a creative work, such as, for example, a song, video, movie, book, game, computer app or program, just to name a few. Those bits are usually organized as a computer file, but they can be organized in other ways, e.g., in object-oriented class instances, structs, records, collections of packets, and so forth. The bits of a DMO at any time can be represented on some physical storage, either volatile or non-volatile, but they always represent the same creative work (excluding, as persons of ordinary skill in the art will appreciate, tags and other metadata, e.g., reflecting DMO ownership, distribution source(s), title and other biographical information, and so forth).

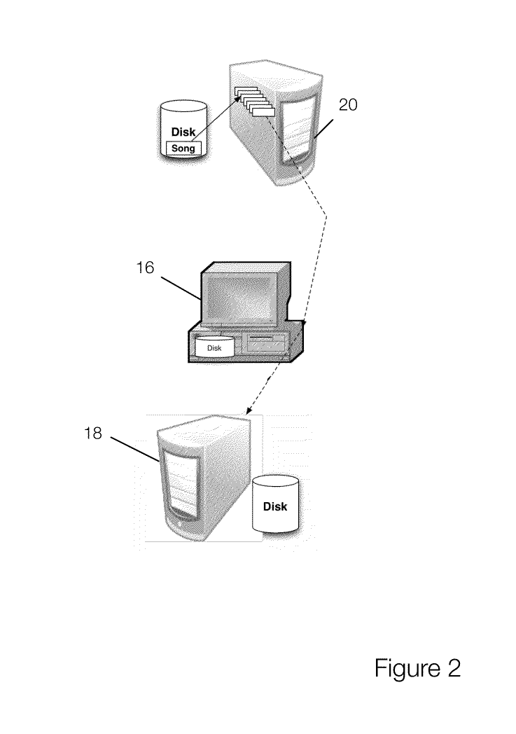

By way of further non-limiting example, client digital data devices 12-16 hereof may operate—albeit, as adapted in accord with the teachings hereof—in the manner of “computer 22” (by way of example) described in co-pending, commonly-assigned U.S. patent application Ser. No. 13/406,237, filed Feb. 27, 2012, and corresponding PCT Patent Application Serial No. PCT/US2012/026,776 (now, Publication No. WO 2012/116365), all entitled “Methods And Apparatus For Sharing, Transferring And Removing Previously Owned Digital Media” (collectively, “Applicant's Prior Applications”) and, more particularly, by way of non-limiting example, in FIGS. 2, 3A and 5 of those applications and in the accompanying text thereof.

Server 18 is a server device of the type employed by a service operator of the type that facilitates the (re)sale, lending, streaming or other transfer of digital music, digital books or other digital media objects. By way of non-limiting example, it may operate in the manner of the ReDigi™ commercial marketplace currently operating at www.redigi.com, as adapted in accord with the teachings hereof Alternatively, or in addition, it may operate in the manner of “remote server 20” described in FIGS. 2, 3A and 5 of Applicant's Prior Applications and in the accompanying text thereof, again, as adapted in accord with the teachings hereof. The server digital data device 18 typically comprises a mainframe computer, minicomputer, or workstation of the type commercially available in the marketplace, as adapted in accord with the teachings hereof, though other devices such as desktop computers, portable computers, tablet computers, smart phones, personal digital assistants or other computer apparatus may be employed as server 18, as well (again, so long as adapted in accord with the teachings hereof).

Servers 20-22 are server devices of the type employed by electronic music, electronic book and other digital media sellers and distributors of the type known in the marketplace, such as Amazon's same-named retail web site, Apple's iTunes website, to name just a few. In the illustrated embodiment, those servers download (e.g., upon purchase or otherwise) to devices 12-18 music files, digital books, video files, games and other digital media objects. Such downloads can be accomplished in the conventional manner known in the art—though, they can also be accomplished utilizing other file transfer techniques, as well. The server digital data devices 20-22 typically comprise mainframe computers, minicomputers, or workstations of the type commercially available in the marketplace, though other devices such as desktop computers, portable computers, tablet computers, smart phones, personal digital assistants or other computer apparatus may be employed as server digital data devices 20, 22, as well. In the illustrated embodiment, the servers 20, 22 are assumed be of the type commercially available and operating in the marketplace. In some embodiments, those servers are modified in accord with the teachings hereof.

Although servers 20-22 are shown, here, as solitary devices, and are also shown as being distinct from the Internet “cloud,” each of those servers is assumed to include intermediate nodes of the Internet infrastructure and/or of a content delivery system forming part of the conventional network via which the respective servers deliver digital media to client devices. Thus, by way of non-limiting example, illustrated servers 20-22 are assumed to include nodes of Akamai, Level 3 Communications, Limelight, Mirror Image Internet, or other content delivery systems utilized by those respective servers 20, 22 to deliver content. Put another way, the servers 20, 22 are each assumed to include all nodes (e.g., other servers, switches, etc.), e.g., in illustrated network 24 or otherwise, within which the DMOs may be permissibly cached and/or stored without violation of copyright in those DMOs and/or which nodes are not under the control of client devices are 12-16 or server 18.

Although servers 18 and 20-22 are drawn separately in the illustrated embodiment, it will be appreciated that in some embodiments their functions and that, moreover, they may be operated by a single party—for example, that serves both as a seller or distributor of digital media, as well as a service operator that facilitates the (re)sale, lending, streaming or other transfer of such media. Likewise, though shown separately, here, in some embodiments the functions of any of the client devices 12-16 may be combined with those of any of servers 18-22.

### Redirection of Digital Media Objects on Purchase or Other Initial Acquisition

Illustrated system 10 is configured to move digital media objects between digital data devices 12-22 to facilitate their (re)sale, lending, streaming or other transfer. More particularly, it is configured to redirect to server 18 (i.e., a server of the type employed by a service operator) DMOs downloaded from servers 20, 22 (i.e., servers of the type employed by a digital media sellers and distributors) in a manner that
circumvents storage of the downloaded DMOs in the first instance on the client devices 12-16, and that instead
effects storage of the downloaded DMOs in the first instance on the server 18, whence they can thereafter be (re)sold, lent, streamed or otherwise transfer between and among client devices 12-16 and their respective users.

Redirection of those downloads to server 18 in accord with the teachings hereof can be employed in connection operation of the system 10 in the manner described in Applicant's Prior Applications, e.g., in which ownership of a DMO on server 18 (which, as noted, can operate in the manner of “remote server 20” described in FIGS. 2, 3A and 5 of Applicant's Prior Applications and in the accompanying text thereof, as adapted in accord with the teachings hereof) is transferred between a seller and a buyer by atomically reallocating from the seller's account to the buyer's account hard disk space in which the DMO is stored on server 18.

Redirection of those downloads to server 18 in accord with the teachings hereof can be employed in connection the operation of the system 10 in other manners, as well, e.g., as where the server 18 is utilized as “cloud” storage for a DMO acquired from servers 20, 22, regardless of whether the user plans to sell or otherwise transfer the DMO to another. Such cloud storage can be utilized, for example, by client devices such as “chrome books,” which comprise disk-less or relatively disk-less computing devices.

As used above and throughout this application, the phrase “in the first instance” is relative as between the server 18 and a client device 12-16 to which a DMO has otherwise been transferred by servers 20, 22. Thus, for example, the phrase reflects that a given DMO, e.g., requested by a user of a client device 16 is stored in the first instance as between client device 16 and server 18 on the latter. The phrase is not intended to exclude the possibility that the DMO might be cached or stored on intermediate nodes of the Internet infrastructure and/or of a content delivery system en route from servers 20, 22 to client device 16 as discussed above.

Redirecting downloaded DMOs to server 18 for storage there in the first instance (as between the server 18 and a client devices 12-16) on purchase or other initial acquisition can be advantageous over prior art systems, in which the downloaded DMOs are, first, stored to respective ones of the client devices on purchase or other initial acquisition and then are, subsequently, uploaded from the client devices 12-16 to server 18.

### Implementation Example

In the illustrated embodiment, such redirection of downloaded DMOs to server 18 for storage there in the first instance on purchase or other initial acquisition by users of devices 12-16 can be effected by redirection manager software 26 operating independently on client digital data devices 12-16 and server 18, though, more typically, is effected by cooperative action of such a software module 26 executing on server 18 and each of the affected client devices 12-16.

In some embodiments, the redirection manager software 26 comprises part of the “management system” or “management software” shown in FIGS. 2, 3A and 5 of Applicant's Prior Applications and described and referred to the accompanying text, e.g., under those names, as well as the names “Manager App. 23” “Manager Application,” and the like, the aforesaid teachings of which prior applications are incorporated herein by reference.

In other embodiments, the redirection manager software 26 is a stand-alone module and/or forms part of the operating system, filesystem, middleware, application layer, or other layers of the software stack of the respective devices 12-18. And, though in the illustrated embodiment the redirection manager software module 26 does not execute on servers 20, 22, in other embodiments it may execute there, as well, in order to further facilitate redirection of downloaded DMOs to server 18 for storage there in the first instance on purchase or other initial acquisition by users of devices 12-16

The redirection manager 26 typically interoperates with other software executing on the respective devices. Thus, for example, the redirection manager software 26 executing on the client devices 12-16 typically interoperates with digital media client software, web browsers and/or other functionality (shown here, collectively, as element 28 and referred to, collectively, below as “digital media client” software) that are utilized to at least initiate purchase and/or other acquisition of DMOs from the servers 20, 22. The redirection manager software 26 may also interact with the operating system, file system, or other components of the respective devices.

FIGS. 2-7 depict a sequence of steps in operation and cooperation of the redirection manager software 26 executing on client device 16 and server 18, both by way of non-limiting example, in connection with redirecting the download of a DMO from a server 20. For sake of simplicity, the DMO is referred to as a “song” and, in this case, is a digital song file—although, the teachings here are equally applicable to other types of digital media objects Further for the sake of simplicity, the other client devices and server that make up system 10 are not shown in these drawings. Nor is shown network 24, although, unbroken and/or dashed lines included in the drawings depict the routing of packets and other signaling among and between client 16, server 18, and server 20 over that network 24.

Construction and operation of the redirection manager software 26 executing on the client device 16 and server 18, respectively, will be readily evident to those skilled in the art in view of the drawings and the accompanying text, as will modifications to the operating system, filesystem, digital media client 28, and/or other components of client 16 in order to effect the illustrated interception/hijacking and redirection. In regard to file creation, storage and other operations, it will be appreciated that the disk drives depicted with devices 16, 18 and 20 in FIGS. 2-7 represent any manner of storage (e.g., embedded drives, attached drives, networked drives, and so forth) by which the respective devices 16, 18 and 20 may maintain digital media objects and/or other data files.

Here, by way of example, the server 20 is assumed to be of the type operated by Apple, Inc. in connection with its iTunes e-commerce ecosystem. In that ecosystem, music files, digital books, video and other DMOs are purchased or otherwise acquired from iTunes digital media server 20 by a user of client device 16, who makes purchase or acquisition requests by way of special-purpose client software (i.e., the iTunes digital media client) executing on device 16. Those skilled in the art will appreciate that the teachings of FIG. 2 and the accompanying text are applicable in other contexts and/or ecosystems, e.g., where purchase or acquisition requests are made from other media servers (e.g., those of Amazon, Google, and so forth), using other special-purpose software, using web browsers, or otherwise.

By way of overview, in the embodiment of FIGS. 2-7, such redirection of downloaded DMOs to server 18 for storage there in the first instance (as between the client by 16 and server 18) on purchase or other initial acquisition by a user of device 16 is effected through the interception or “hijacking”, on client device 16, of instructions executed by the digital media client 28 in order to
redirect to server 18 packets that (a) embody respective portions of a DMO requested for purchase or acquisition download by a user of the digital media client 28 and (b) are transmitted from server 22 client device 16,
prevent reassembly of those packets into the DMO on the client device 16 (until the DMO has, first, been stored to server 18), and
effect reassembly of those packets into the DMO on server 18 for storage there in the first instance following purchase or acquisition of the DMO by the user. As noted above, it will be appreciated that the phrase “in the first instance” as used here is relative as between the server 18 and the client device 16 and is not intended to exclude the possibility that the DMO might be cached or stored on intermediate nodes of the Internet infrastructure and/or of a content delivery system en route from servers 20, 22 to client device 16 as discussed still earlier.

In essence, redirection of the DMO packets from the client device 16 to the server 18 has the effect of turning the client device 16 into a “switch” along the way to server 18. As those skilled in the art will appreciate, when servers transmit packets over the Internet, those packets pass through many intermediate switches (or routers). The client device 16, here, is at least initially acting just like another intermediate switch.

### Beginning the Redirection

Referring to FIG. 2, the server 20 begins downloading packets representing a DMO requested by client device 16 and more particularly, for example, by the digital media client application 28 executing on that device 16. Initiation of such a download occurs in the conventional manner known in the art, e.g., in response to a request by the user of device 16 to purchase or otherwise acquire the DMO from the digital media server 20. In other embodiments, the download may be initiated in response to another form of request made via client software 28, a web browser or otherwise. Indeed, such a download may be initiated by a third-party and/or by server 20, of its own accord.

With respect to the sequence of operations depicted in FIG. 2, the server 20 (e.g., the Apple digital media server) has a disk with a DMO, i.e., a song file, to be downloaded, as well as a processor with a connection to network 24. In the normal course of operation, the server 20 sends packets embodying respective portions of the DMO (here, again, a song file) over network 24 to client device 16, e.g., a user's personal computer. In the case of a typical DMO, many (1000 or more) such packets will be streamed, taking many seconds or minutes for all to be sent. For example, a typical DMO may be about 10 MB (million bytes) and is divided into packets, each packet is a couple of kilo bytes (thousands of bytes) in size.

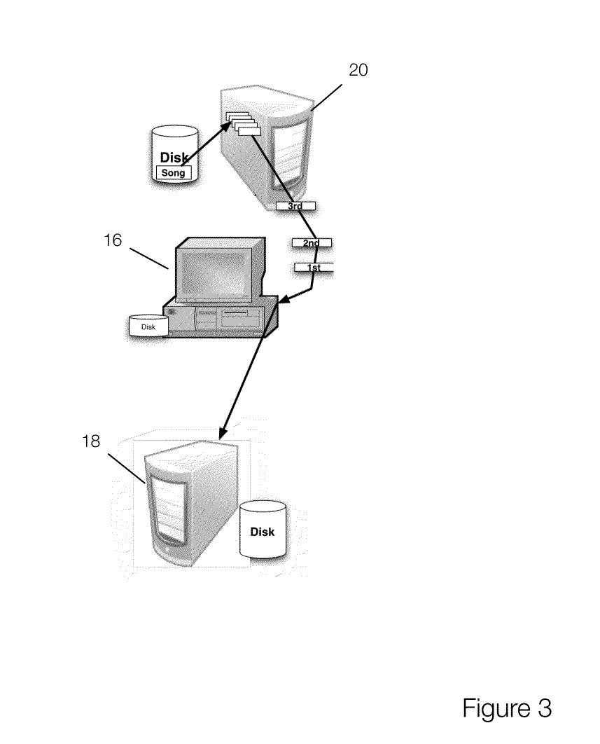

The foregoing is more fully depicted in FIG. 3, which shows:
1. The DMO being read from the disk of server 20 in the conventional manner known in the art
2. The DMO being packetized in the conventional manner known in the art
3. The packets being streamed to client device 16 over network 24 in the conventional manner known in the art.

Referring back to FIG. 2, the operating system of the client device 16 receives packets from the server 20 and stores them in a buffer. [As those packets are read by the digital media client 28 executing on device 16 (i.e., the digital media client application 28), the buffer is reused for additional incoming packets.] Typically, that buffer is small relative to the expected size of the DMO so that no substantial portion of the DMO is maintained in it (the buffer) at any one time.

Simultaneously, the digital media client 28 gets packets from the operating system of device 16 into its own local buffer. The digital media client 28 issues calls to the filesystem (or other functionality) of device 16 to (i) write those packets to a temporary file on disk, and (ii) append each batch of packets to the end of the file, e.g., by executing operations in the nature of:

Create File (“Song.Partial”)

Repeat Until Last Packet Received
Fetch Packets into Buffer (N bytes fetched)
Append_To_File(Buffer, N bytes)

The redirection manager 26 executing on device 16 operating independently and/or in cooperation with the operating system and/or filesystem of that device 16, intercepts/hijacks file system operations (e.g., create, rename, write, read operations) made to the folder or directory on device 16 associated with the digital media client 28. This includes file system operations in the nature of CreateFile and Append_To_File calls made by the digital media client 28. This redirection manager 26 transmits those intercepted calls and accompanying packets, data and other information to server 18. The redirection manager 26 executing on device 16 may supplement or alter those calls in connection with their transmission to server 18, e.g., in accord with a protocol for cooperation with the counterpart redirection manager 26 executing on the server 18.

In some embodiments, the redirection manager 26 executing on device 16 effects such interception/hijacking of calls made by the digital media client 28 through use of an interrupt-handling mechanism provided with the operating system of that device that cedes control to the redirection manager 26 on the occurrence of calls affecting a download folder or directory to which the digital media client 28 is expected to write newly received DMO packets from server 20. In other embodiments, the redirection manager 26 is invoked by a pseudo-filesystem that intercepts and passes to the redirection manager 26 selected such calls, e.g., file system calls that affect files in digital media client download folder, and that releases other calls to the regular filesystem of device 16. In still other embodiments, e.g., where the digital media client 28 comprises a web browser or web browser-like application, the redirection manager 26 is invoked when the browser or browser-like application is invoked by the user to download DMOs from selected sites, e.g., as discerned, for example, from the DOMs (document object model) of webpages of those sites. Those skilled in the art will appreciate these and other mechanisms may be used to intercept filesystem calls in accord with the teachings hereof.

Thus, for example, in response to intercepted Create File and Append_To_File calls, the redirection manager 26 executing on device 16 may effect the following actions:

If File Action is Create File:
Send to Server 18 “Upload File” named Song

If File Action is Append_To_File:
Send the bytes to Buffer in Server 18

By intercepting these and other file system calls by the digital media client 28, the redirection manager 26 prevents the packets from being stored by that digital media client 28 to device 16, e.g., in the temporary file Song.Partial or otherwise.

In some embodiments, e.g., those in which the DMO and its packets are downloaded from the iTunes digital media server 20 (or other servers that act in a similar manner in regards relevant hereto), the digital media client 26 executing on the client device 16 permits selected file system calls by the digital media client 28 to be executed by the file system of device 16 in addition to redirecting those calls (or altered/supplemented versions thereof) to the server 18. Those selected calls are the Create File call and certain ones of the Append_To_File calls, among others. The specific ones of those calls permitted to be executed on the file system of device 16 are those necessary to permit the digital media client 28 to execute and are determined empirically.

The redirection manager may be activated for the foregoing purposes at the request of the user of the client digital data device 12-16 to which the download would otherwise occur, e.g., as where that user responds to a prompt by redirection manager 26 (or otherwise) querying the user whether the download of a newly purchased DMO should be directed to server 18. Alternatively or in addition, such a request may be initiated by other software executing on the client digital data device, e.g., as where a web browser, a digital media client application (e.g., iTunes) or file system software executing on that client 16 generates a request to the redirection manager 26 in connection with filesystem operations directed to a specific folder or directory on the device 16 and/or in connection with an in-process purchase and/or download from a server 20. Still further, alternatively or in addition, such a request may be initiated by the server 20 from which the download is to be made, e.g., in connection with preparing the DMO for transfer.

The redirection manager 26 executing on server 18 responds to the intercepted CreateFile call by creating a file and associating it with an account on server 18 owned by the user of client device 16. That redirection manager 26 responds to the intercepted Write_To_File calls by storing packets transmitted with those calls to the newly opened file In embodiments where it is employed in connection with operation of a system of the type described in Applicant's Prior Applications, the redirection manager 26 executing on device 18 invokes the management software described in those prior applications to perform the same actions as it would usually perform upon upload of a file from a client device.

With reference to FIGS. 2 and 3, if the download of a DMO from server 20 fails in the middle, the partial files, e.g., Song.Partial, may be deleted. The redirection manager software 26 executing on client 16 and server 18 may take such additional steps as are necessary to ensure that the user will not see a file that looks valid but is only partial.

### Continuing the Redirection

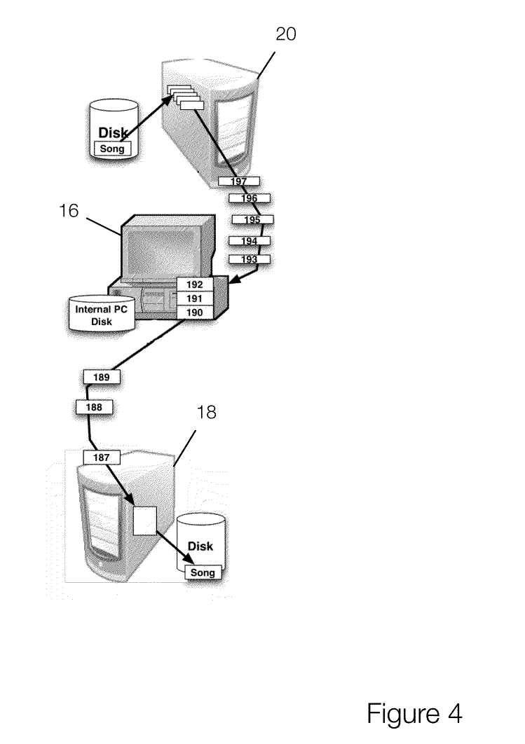

Referring to FIG. 4, there are shown further operations executed by the illustrated system 10 in connection with redirection of the DMO from client device 16 to server 18.

As shown in that drawing, the server 20 continues to send packets embodying respective portions of the song file over network 24 to client device 16. Likewise, the operating system and digital media client 28 of the client device 16 continue to receive those packets and store them in a buffer and in the temporary file Song.Partial, respectively. Moreover, the redirection manager 26 executing on device 16 continues to send intercepted file system calls to the server 18.

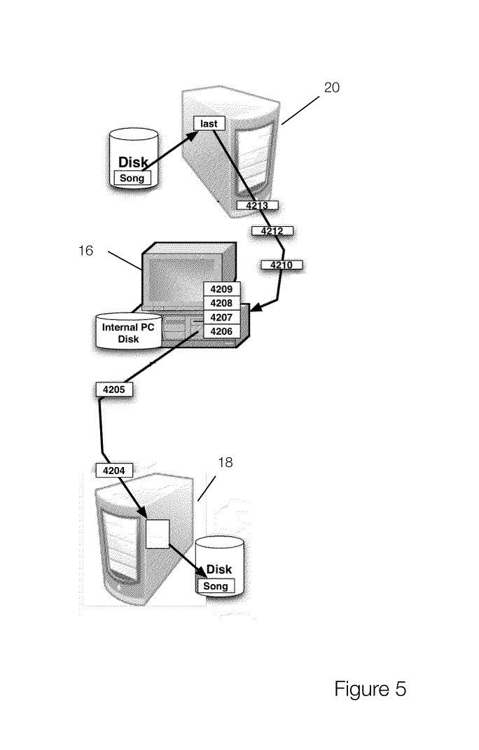

Referring to FIG. 5, there are shown further operations executed by the illustrated system 10 in connection with redirection of the song file DMO from client device 16 to server 18. Particularly, that drawing shows that the operations discussed in connection with FIG. 4 continue until the last packet transmitted by server 22 client 16 has been redirected to server 18 and stored there.

### Completing the Redirection

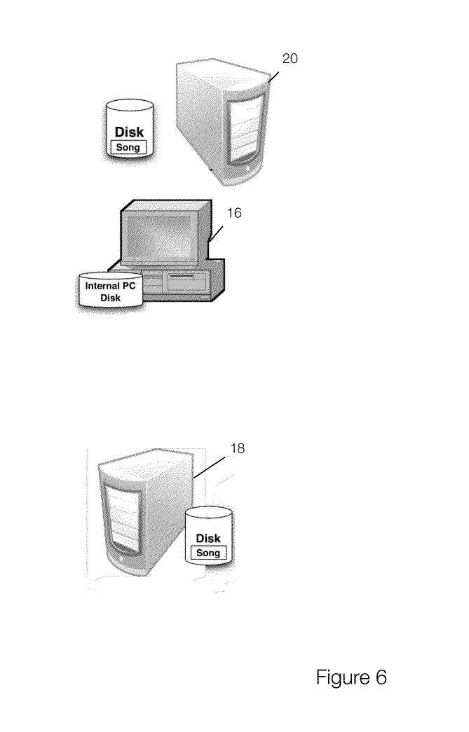

Referring to FIG. 6, there are shown further operations executed by the illustrated system 10 in connection with redirection of the song file DMO from client device 16 to server 18. Particularly, that drawing shows operations executed when the last packet has been transmitted by server 22 to client 16 has been redirected to server 18 and stored there. At that stage, which the digital media client 28 may detect by way of receipt of an EOF packet from server 20 and/or by way of comparing transmitted and received file sizes, the digital media client 28 issues a call to close the temporary file and, concurrently, to rename the temporary file

Close File(“Song.Partial”)

Rename(“Song.Partial”, “Song”)

Upon intercepting those calls, the redirection manager 26 executing on client device 16 sends an “upload complete” packet (or other message) to its counterpart redirection manager 26 on server 18:

If File Action is Close File:
Tell Server 18 “upload done”

While, in some embodiments, it may be necessary to transmit the intercepted Rename operation to server 18, in the illustrated example this is unnecessary due to the cooperative protocol between the redirection managers 26 (which calls for transmission of the DMO title—in this case, the song title—at the outset of the redirection process; see, the discussion above in connection with FIG. 2).

### Storing a Copy of the DMO to the Client

Although not required in all embodiments of the invention, in some embodiments, it may be desirable to transfer the DMO (or a copy thereof) to the client device 16 after completion of the upload to server 18, i.e., after the DMO has been stored to the server 18. This can be by default or upon request of the user of device 16 (e.g., as where he/she indicates, when utilizing the digital media client 28 to request download of the DMO from server 20, that he/she wishes to have the DMO (or a copy thereof) stored to device 16 after the downloaded DMO has been stored to server 18).

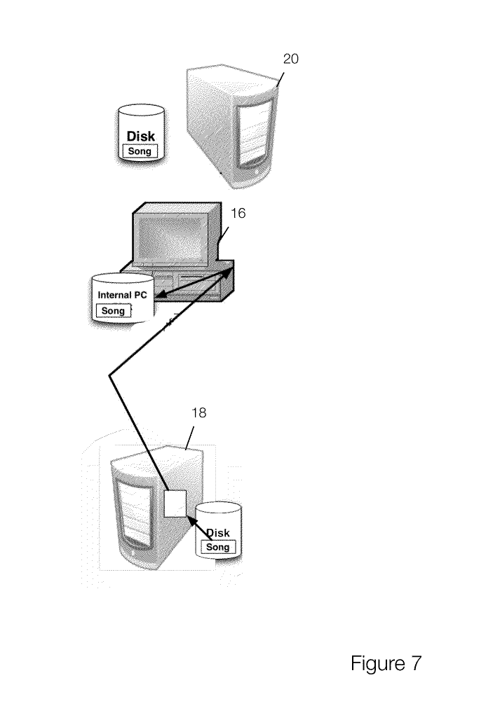

Referring to FIG. 7, in the illustrated embodiment, the redirection manager 26 on device 16 effects such a download by default. Specifically, manager 26 responds to interception of the Rename call from the digital media client 28 by triggering a download of the DMO (or a copy thereof) from server 18, e.g., as follows:

If File Action is Rename:
Download file from Redigi to PC

Once the DMO (or copy) is downloaded to client 16, the redirection manager 26 executing on that device can notify the digital media client 28 so that the song (or other DMO) appears to the user of client 16 as if it had been downloaded to client device 16 in the first instance.

Other embodiments utilize different methodologies to store a copy of the DMO to the client device 16 after completion of its upload to server 18. In those embodiments, in addition to transferring to server 18 packets received from server 20 (e.g., as shown in FIGS. 2-5 and discussed above), the redirection manager 26 executing on device 16 retains some or all of those packets in a unusable form on client 16, e.g., preferably, in a temporary, hidden filed on that device 16.

As used herein, “unusable” refers to a form whence the DMO cannot be assembled from the retained packets without a key or other information that is generally unavailable to device 16 or the user thereof.

Only after completion of the upload to server 18 of the packets from server 20 does redirection manager 26 executing on device 16 render the retained, unusable packets usable and, more particularly, does the redirection manager convert those unusable packets into a useable form and assemble a copy of the DMO therefrom. The redirection manager 26, then, stores that copy of the DMO on the device 16.

In some of the aforementioned embodiments, the redirection manager 26 executing on device 16 renders the retained packets in unusable form by encrypting them, e.g., with a public key, e.g., provided by counterpart redirection manager 26 executing on server 18 at the outset of the redirection process; provided by server 20; or provided by some other source. After completion of the upload to server 18 of the packets from server 20, the redirection manager 26 executing on device 16 obtains a corresponding private key from the same source and uses it to decrypt the unusable packets into a useable form, whence it assembles a copy of the DMO and stores it on device 16.

In others of the aforementioned embodiments, the redirection manager 26 executing on device 16 renders the retained packets in unusable form by deleting selected ones of them, e.g., the first packet of the DMO, every other packet from the DMO, every third packet of the DMO; and so forth. After completion of the upload to server 18 of the packets from server 20, the redirection manager 26 executing on device 16 (re-)obtains the deleted packet(s), e.g., from its counterpart manager 26 executing on server 18 (or from some other source), and combines them with the retained, unusable packets to render useable, whence the manager 26 executing on device 16 assembles a copy of the DMO and stores it on device 16.

As above, once that copy of the DMO is stored on client 16, the redirection manager 26 executing on that device notifies the digital media client 28 so that the song (or other DMO) appears to the user of client 16 as if it had been downloaded to client device 16 in the first instance.

Described above and shown in the drawings are systems and methods meeting the objects set forth herein, among others. It will be appreciated that the embodiments here are mere examples of the invention, and that others employing changes hereto fall within the scope of the invention. Thus, for example, it will be appreciated that, although the example shown in FIGS. 2-7 involve redirection of packets as they are written by a digital media client executing on client device, other embodiments may perform such redirection of packets as they are downloaded to a web browser or other software executing on the client device that facilitates the download of DMOs from a media server 20, 22 to the client.

By way of further example, although the embodiment of FIG. 7 downloads a digital media object (or copy) to the client device after the DMO has been stored to the server 18, in other embodiments no such download is performed, e.g., unless specifically requested by the user or other.

By way of still further example, although the embodiments of FIGS. 2-7 refer to a song file-type digital media object, the teachings hereof apply as well to other types of digital media objects, including, by way of nonlimiting example, videos, books, games, software, and so forth, just to name a few.

By way of yet still further example, although the embodiments of FIGS. 2-7 redirect packets comprising a DMO by intercepting file system calls issued by the digital media client 28, other embodiments may redirect packets before they are passed to the digital media client or other application or software executing on device 16. These other embodiments can, instead, employ a packet rerouter that operates at the hardware level (e.g., in the network interface hardware) or software network interface level of the device. Such a packet rerouter can detect packets destined for the digital media client (e.g., based on port number) and can pass those packets directly to the server 18. As those skilled in the art will appreciate, a packet rerouter that operates within a virtual machine environment can readily capture packets at the “hardware” level, thus, facilitating such rerouting in implementations of the client device 16 within such virtual machines.

In view of the foregoing, what is claimed is:

1. A digital commerce system, comprising:
A. a first digital data device, a second digital data device and a third digital data device,
B. a network to which each of the first digital data device, second digital data device, and third digital data device are at least intermittently coupled, the network providing at least intermittent communications coupling between the second digital data device and each of the first digital data device and the third digital data device,
C. redirection logic executing on at least the second digital data processor that effects storage on the third digital data processor of a digital media object downloaded from the first digital data device to the second digital data device,
D. wherein the redirection logic executing on the second digital data device effects storage of the digital media object on the third digital data device before that digital media object is stored to the second digital data device, if at all.

2. The digital commerce system of claim 1, wherein
the first digital data device and third digital data device are server devices, and
the second digital data device is a client device.

3. The digital commerce system of claim 2, wherein the first digital data device is a digital media server.

4. The digital commerce system of claim 1, wherein redirection logic executing on at least the second digital data device circumvents storage of the downloaded digital media object there at least until that digital media object has been stored on the third digital data device.

5. The digital commerce system of claim 1, wherein
the second digital data device executes digital media client software that requests a download of the digital media object, and
the first digital data device is a digital media server that initiates the download in response to that request.

6. The digital commerce system of claim 5, wherein the digital media client software makes that request at the behest of a user of the second digital data device who seeks to purchase or otherwise acquire the digital media object from the first digital data device.

7. The digital commerce system of claim 1, wherein the first digital data device responds to a request from the second digital data device by packetizing the digital media object and sending resultant packets to the second digital data device.

8. The digital commerce system of claim 7, wherein the packets embody respective portions of the digital media object.

9. The digital commerce system of claim 7, wherein the digital media client responds to packets received by the second digital data device from the first digital data device by issuing calls to write those packets to a file on the second digital data device.

10. The digital commerce system of claim 9, wherein the redirection logic executing on the second digital data device effects interception of file system operation calls, including calls to write packets to the file, issued by the digital media client.

11. The digital commerce system of claim 10, wherein the redirection logic executing on the second digital data device effects such interception in cooperation with the operating system and/or filesystem of the second digital data device.

12. The digital commerce system of claim 10, wherein the redirection logic executing on the second digital data device transmits the intercepted calls to the third digital data device.

13. The digital commerce system of claim 12, wherein the redirection logic executing on the second digital data device transmits the intercepted calls to the third digital data device along with packets, data and/or other information that accompanied the intercepted calls.

14. The digital commerce system of claim 12, wherein the redirection logic executing on the second digital data device supplements or alters the intercepted calls that are transmitted to the third digital device.

15. The digital commerce system of claim 14, wherein the redirection logic executing on the second digital data device supplements or alters the intercepted calls in accord with a protocol for cooperation with redirection logic executing on the third digital data device.

16. The digital commerce system of claim 10, wherein the redirection logic executing on the second digital data device transmits packets received with the intercepted calls to the third digital data device.

17. The digital commerce system of claim 16, wherein by intercepting calls issued by the digital media client the redirection logic executing on the second digital data device prevents packets in those calls from being stored to the second digital data device.

18. The digital commerce system of claim 16, wherein the redirection logic executing on the second digital data device retains the transmitted packets in unusable form on the second digital data device.

19. The digital commerce system of claim 18, wherein the unusable form is a form whence the DMO cannot be assembled from the retained packets without a key or other information that is generally unavailable to second digital data device of a user thereof.

20. The digital commerce system of claim 18, wherein the redirection logic executing on the second digital data device encrypts the retained packets using a key provided by the first digital data device, the third digital data device or by some other source.

21. The digital commerce system of claim 18, wherein the redirection logic executing on the second digital data device renders the retained packets unusable by deleting selected ones of those packets.

22. The digital commerce system of claim 16, wherein the redirection logic executing on the second digital data device continues transmitting packets received with the intercepted calls to the third digital data device until the last packet embodying a portion of the digital media object is received by the second digital data device from the first digital data device and is transmitted to the third digital data device.

23. The digital commerce system of claim 16, wherein the redirection logic executing on the second digital data device effects downloading of the digital media object or a copy thereof from the third digital data device to the second digital data device after the last packet embodying a portion of the digital media object is received by the second digital data device from the first digital data device and is transmitted to the third digital data device.

24. The digital commerce system of claim 16, wherein
A. the redirection logic executing on the second digital data device retains the transmitted packets in unusable form on the second digital data device,
B. after the last packet embodying a portion of the digital media object is received by the second digital data device from the first digital data device and is transmitted to the third digital data device, the redirection logic executing on the second digital data device renders the retained, unusable packets usable, assembles them into a copy of the digital media object, and stores that copy to the second digital data device.

25. The digital commerce system of claim 24, wherein the redirection logic executing on the second digital data device renders the retained, unusable packets usable by decrypting using a key provided by the first digital data device, the third digital data device or by some other source.

26. The digital commerce system of claim 25, wherein the redirection logic executing on the second digital data device renders the retained, unusable packets usable by combining them with packets representing portions of the digital media object provided by the first digital data device, the third digital data device or by some other source.

27. The digital commerce system of claim 1, wherein the redirection logic redirect packets before they are passed to a digital media client, other application or other software executing on the second digital data device.

28. The digital commerce system of claim 27, wherein the redirection logic comprises packet rerouter logic that operates at a hardware level of the second digital data device.

29. The digital commerce system of claim 27, wherein the redirection logic comprises packet rerouter logic that operates at a software network interface level of the second digital data device.

30. The digital commerce system of claim 27, wherein the redirection logic comprises packet rerouter logic that detects packets destined for the digital media client and passes those packets to the third digital data device.

31. The digital commerce system of claim 27, wherein
the second digital data device executes within a virtual machine environment,
the redirection logic comprises packet rerouter logic that operates at a virtual hardware level of the second digital data device within that virtual machine environment.

32. A method of digital commerce system, comprising:
A. providing at least intermittent coupling between a first digital data device and a second digital data device, as well as between the second digital data device and a third digital data device,
B. effecting storage on the third digital data processor of a digital media object downloaded from the first digital data device to the second digital data device,
C. wherein such storage of the digital media object on the third digital data device is effected before that digital media object is stored on the second digital data device, if at all.

33. The method of claim 32, wherein step (B) includes circumventing storage of the downloaded digital media object on the second digital data device at least until that digital media object has been stored on the third digital data device.

34. The method of claim 32, comprising responding to a request from the second digital data device by packetizing the digital media object on the first digital data device and sending resultant packets to the second digital data device.

35. The method of claim 32, comprising responding to packets received by the second digital data device from the first digital data device by issuing calls on the second digital data device to write those packets to a file on the second digital data device.

36. The method of claim 35, wherein step (B) includes intercepting file system operation calls, including said calls to write packets to the file, issued on the second digital data device.

37. The method of claim 36, wherein step (B) includes transmitting the intercepted calls to the third digital data device.
